(19) United States
(12) Patent Application Publication
(10) Pub. No.: US 2021/0199482 A1
(43) Pub. Date: Jul. 1, 2021

(54) FLOWMETER

(71) Applicant: DENSO CORPORATION, Kariya-city (JP)

(72) Inventors: Seiji YAOKO, Nisshin-city (JP); Kazuaki UEDA, Nisshin-city (JP); Shota TODA, Nisshin-city (JP); Yuusuke YOSHIDA, Nisshin-city (JP); Kengo ITO, Kariya-city, Aichi-pref. (JP)

(21) Appl. No.: 17/203,359

(22) Filed: Mar. 16, 2021

Related U.S. Application Data
(63) Continuation of application No. PCT/JP2019/035181, filed on Sep. 6, 2019.

(30) Foreign Application Priority Data
Sep. 19, 2018 (JP) 2018-174658

(51) Int. Cl. G01F 1/684; F02D 41/18; G01F 15/14

(52) U.S. Cl. CPC G01F 1/6847; G01F 15/14; F02D 41/18

(57) ABSTRACT

A flowmeter includes a hollow housing, a first passage, a second passage, a detector, and a flat surface. The housing includes a first side wall and a second side wall and defines an inlet opening and an outlet opening that is defined in the first side wall. The first passage fluidly connects between the inlet opening and the outlet opening. The second passage branches off from the first passage. The detector is disposed in the second passage and configured to detect a flow rate of the target fluid flowing through the second passage. The flat surface is an outer surface of the first side wall and extends between an upstream end of the first side wall and the outlet opening along the main flow direction.

### CROSS REFERENCE TO RELATED APPLICATION

The present application is a continuation application of International Patent Application No. PCT/JP2019/035181 filed on Sep. 6, 2019, which designated the U.S. and claims the benefit of priority from Japanese Patent Application No. 2018-174658 filed on Sep. 19, 2018. The entire disclosures of all of the above applications are incorporated herein by reference.

### TECHNICAL FIELD

The present disclosure relates to a flowmeter.

### BACKGROUND ART

A flowmeter takes the target fluid into a housing, separates water and foreign matters such as particles from the target fluid by a branching structure of a passage in the housing, and detects a flow rate of the target fluid separated from foreign matters with a detector.

### SUMMARY

A flowmeter is configured to measure a flow rate of a target fluid flowing through a pipe. The flowmeter includes a hollow housing, a first passage, a second passage, a detector, and a flat surface. The housing includes a first side wall and a second side wall facing each other in a direction intersecting a main flow direction of the target fluid. The housing defines an inlet opening that opens toward an upstream end of the pipe in the main flow direction and an outlet opening that is defined in the first side wall. The target fluid flows into the housing through the inlet opening and out of the housing through the outlet opening. The first passage is defined in the housing and fluidly connects between the inlet opening and the outlet opening. The target fluid flows through the first passage. The second passage is defined in the housing and branches off from the first passage. A portion of the target fluid flowing through the first passage flows into the second passage. The detector is disposed in the second passage and configured to detect a flow rate of the target fluid flowing through the second passage. The flat surface is an outer surface of the first side wall and extends between an upstream end of the first side wall in the main flow direction and the outlet opening along the main flow direction.

### BRIEF DESCRIPTION OF DRAWINGS

FIG. 1 is a schematic view of a combustion system.

FIG. 2 is a schematic cross-sectional view of a pipe at an attachment position of a flowmeter.

FIG. 3 is a schematic plane view of a fixing portion of the flowmeter fixed to the pipe.

FIG. 4 is a schematic cross-sectional view of the flowmeter of a first embodiment taken along a line IV-IV in FIG. 2.

FIG. 5 is a schematic cross-sectional view of a housing of the first embodiment taken along a line V-V in FIG. 4.

FIG. 6 is a schematic cross-sectional view of a housing of a flowmeter of a second embodiment.

FIG. 7 is a schematic cross-sectional view of a housing of a flowmeter of a third embodiment.

FIG. 8 is a schematic cross-sectional view of a housing of a flowmeter of a fourth embodiment.

FIG. 9 is a schematic cross-sectional view of a housing of a flowmeter of a fifth embodiment.

FIG. 10 is a schematic cross-sectional view of a housing of a flowmeter of a sixth embodiment.

FIG. 11 is a schematic cross-sectional view of a housing of a flowmeter of a seventh embodiment.

FIG. 12 is a schematic cross-sectional view of a housing of a flowmeter of an eighth embodiment.

FIG. 13 is a schematic cross-sectional view of a housing of a flowmeter of a ninth embodiment.

FIG. 14 is a schematic cross-sectional view of a housing of a flowmeter of a tenth embodiment.

FIG. 15 is a schematic cross-sectional view of a housing of a flowmeter of an eleventh embodiment.

FIG. 16 is a schematic cross-sectional view of a housing of a flowmeter of a twelfth embodiment.

FIG. 17 is a schematic cross-sectional view of a housing of a flowmeter of a thirteenth embodiment.

FIG. 18 is a schematic cross-sectional view of a housing of a flowmeter of a fourteenth embodiment.

FIG. 19 is a schematic cross-sectional view of a housing of a flowmeter of a fifteenth embodiment.

FIG. 20 is a schematic cross-sectional view of a housing of a flowmeter of a sixteenth embodiment.

FIG. 21 is a schematic cross-sectional view of a housing of a flowmeter of a seventeenth embodiment.

FIG. 22 is a schematic cross-sectional view of a housing of a flowmeter of an eighteenth embodiment.

### DESCRIPTION OF EMBODIMENTS

To begin with, examples of relevant techniques will be described. Various flowmeters configured to measure a flow rate of a target fluid flowing through a pipe are proposed. For example, a flowmeter takes the target fluid into a housing, separates water and foreign matters such as particles from the target fluid by a branching structure of a passage in the housing, and detects a flow rate of the target fluid separated from foreign matters with a detector. The pipe has a protrusion at an upstream end of an outlet opening in a forward flow direction of the target fluid. The protrusion generates a negative pressure around the outlet opening and guides water and foreign matters such as particles outward of the housing.

However, when a negative pressure is generated around the outlet opening, the negative pressure may generate an unusual and unexpected flow of the target fluid in a passage connected to a detector in the housing. It is preferable for the flowmeter that the unexpected flow of the target fluid in the housing be restricted from generating to restrict measurement errors.

Techniques of the present disclosure can be achieved in the following embodiments.

A first aspect of the present disclosure is provided as a flowmeter configured to measure a flow rate of a target fluid flowing through a pipe. The flowmeter includes a hollow housing, a first passage, a second passage, a detector, and a flat surface. The housing includes a first side wall and a second side wall facing each other in a direction intersecting a main flow direction of the target fluid. The housing defines an inlet opening that opens toward an upstream end of the pipe in the main flow direction and an outlet opening that is defined in the first side wall. The target fluid flows into the housing through the inlet opening and out of the housing through the outlet opening. The first passage is defined in the housing and fluidly connects between the inlet opening and the outlet opening. The target fluid flows through the first passage. The second passage is defined in the housing and branches off from the first passage. A portion of the target fluid flowing through the first passage flows into the second passage. The detector is disposed in the second passage and configured to detect a flow rate of the target fluid flowing through the second passage. The flat surface is an outer surface of the first side wall and extends between an upstream end of the first side wall in the main flow direction and the outlet opening along the main flow direction.

According to the flowmeter, the outlet opening opens in a direction intersecting the main flow direction in the pipe. Thus, when a portion of the target fluid reversely flows through the pipe, a dynamic pressure of the reverse flow of the target fluid is restricted from transmitting to the passage in the housing through the outlet opening. As a result, vortices generated by the target fluid flowing into the housing through the outlet opening are reduced in the passage of the housing. Further, the flat surface is disposed between a front wall and the outlet opening, so that the target fluid can flow smoothly around the outlet opening and a negative pressure is restricted from generating around the outlet opening. Therefore, an unexpected flow of the target fluid which is caused by the negative pressure around the outlet opening can be restricted from generating in the passage of the housing.

### 1. First Embodiment

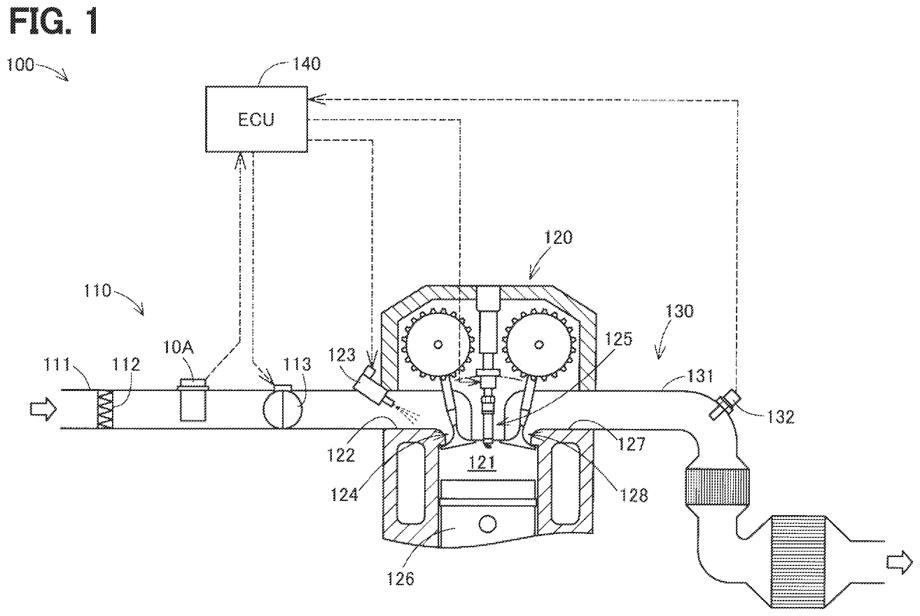

With reference to FIG. 1, a flowmeter 10A of a first embodiment is used, for example, in a combustion system 100. The combustion system 100 is mounted in a vehicle or the like and generates a driving force of the vehicle. The combustion system 100 includes an intake portion 110, an internal combustion engine 120, an exhaust portion 130, and an ECU 140. The flowmeter 10A is included in the intake portion 110.

The intake portion 110 includes a pipe 111, an air cleaner 112, and a throttle valve 113 in addition to the flowmeter 10A. The pipe 111 is connected to the internal combustion engine 120. Through the pipe 111, an intake air supplied to the internal combustion engine 120 flows. The intake air may contain an exhaust gas as described later. Hereinafter, a direction in which the intake air flows toward a combustion chamber 121 through the pipe 111 along a center axis of the pipe 111 is referred to as “a main flow direction”.

The air cleaner 112, the flowmeter 10A, and the throttle valve 113 are attached to the pipe 111 in this order from an upstream end of the pipe 111 in the main flow direction. The air cleaner 112 removes dusts in the intake air. The flowmeter 10A measures a flow rate of the intake air. In the combustion system 100, the intake air is a target fluid measured by the flowmeter 10A and a measurement result of the flowmeter 10A shows an amount of the intake air. The throttle valve 113 adjusts an amount of the intake air to be supplied to the internal combustion engine 120.

The internal combustion engine 120 includes the combustion chamber 121, an intake air passage 122, an injector 123, an intake air valve 124, an ignition plug 125, a piston 126, an exhaust air passage 127, and an exhaust air valve 128. The combustion chamber 121 is fluidly connected to the pipe 111 of the intake portion 110 through the intake air passage 122.

The injector 123 and the intake air valve 124 are disposed in the intake air passage 122. The injector 123 injects a fuel into the intake air flowing from the pipe 111 into the intake air passage 122 and mixes them. The mixed gas of the intake air and the fuel flows into the combustion chamber 121. The intake air valve 124 are disposed at an outlet of the intake air passage 122. The inflow of the mixed gas into the combustion chamber 121 is controlled by an opening/closing of the intake air valve 124.

The ignition plug 125 ignites the mixed gas flowing into the combustion chamber 121. In the internal combustion engine 120, a combustion pressure of the mixed gas in the combustion chamber 121 presses and moves the piston 126. The combustion chamber 121 is fluidly connected to the exhaust portion 130 through the exhaust air passage 127. The exhaust air valve 128 is disposed at an inlet of the exhaust air passage 127. The discharge of the exhaust gas from the combustion chamber 121 to the exhaust air passage 127 is controlled by an opening/closing of the exhaust air valve 128.

The exhaust portion 130 includes an exhaust gas pipe 131 and an air-fuel ratio sensor 132. The exhaust gas pipe 131 is fluidly connected to the exhaust air passage 127 and guides the exhaust gas discharged out of the combustion chamber 121 to an outside of the vehicle. A portion of the exhaust gas may be mixed with the intake air in the pipe 111 through a circulation passage (not shown). The air-fuel ratio sensor 132 is attached to the exhaust gas pipe 131 and configured to detect an amount of oxygen in the exhaust gas.

The ECU 140 controls an operation of the combustion system 100. The ECU 140 is a calculation processing circuit configured with a microcomputer, a power supply, and the like. The microcomputer includes, for example, a processor (hereinafter referred to as a “CPU”), a storage medium such as RAM, ROM, and a flash memory, and an input/output portion. The ECU 140 executes a program and a command read by the CPU on the RAM to control the combustion system 100. At least a part of functions of the ECU 140 may be performed by an analogue circuit configuring the ECU 140.

For example, the ECU 140 controls an opening degree of the throttle valve 113 or an amount of the fuel injected by the injector 123 using measuring results of the flowmeter 10A, the air-fuel ratio sensor 132, a combustion pressure sensor (not shown), and the like. The ECU 140 also controls the opening-closing of the intake air valve 124 and the exhaust air valve 128 and the ignition of the mixed gas by the ignition plug 125. The ECU 140 may control an amount of EGR.

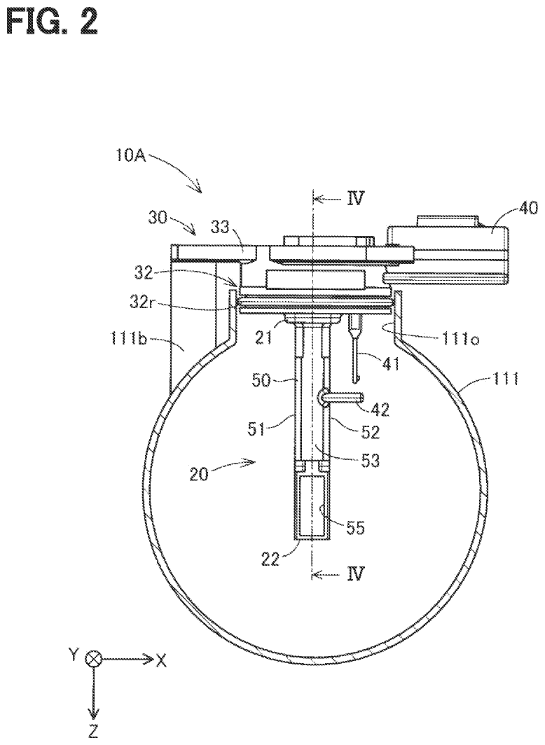

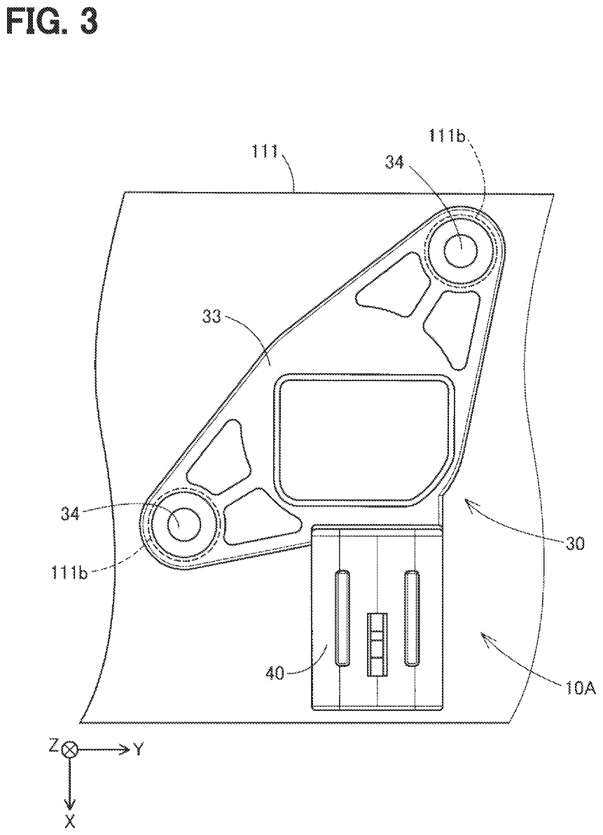

With reference to FIGS. 2 and 3, X, Y, and Z axes are shown as three direction perpendicular to one another. A X direction is perpendicular to a center axis of the pipe 111 at an attachment position of the flowmeter 10A. The X direction heads toward a right side when a Z direction heads downward and viewed along a Y direction. The Y direction is parallel to the center axis of the pipe 111 at the attachment position of the flowmeter 10A and corresponds to the main flow direction of the target fluid at the attachment position. The Z direction corresponds to an inserting direction in which a body portion 20 of the flowmeter 10A is inserted into the pipe 111. The X, Y, and Z axes are appropriately shown in other drawings. In the following descriptions, unless otherwise noted, the X direction, the Y direction, and the Z direction mean positive directions and −X direction, −Y direction, and −Z direction mean negative directions opposite to the positive directions.

With reference to FIG. 2, the flowmeter 10A includes the body portion 20, a fixing portion 30, and a connector portion 40. The body portion 20 is disposed in the pipe 111 and exposed to the target fluid. The fixing portion 30 is fixed to the pipe 111. The connector portion 40 are disposed outside of the pipe 111. The body portion 20 is inserted into the pipe 111 in the Z direction through an opening 110o defined in the pipe 111. A configuration of the body portion 20 will be described in detail later.

As shown in FIG. 2, the fixing portion 30 is connected to a base end portion 21 of the body portion 20 around the opening 110o of the pipe 111. Since the fixing portion 30 is fixed to the opening 110o of the pipe 111, a tip end portion 22 of the body portion 20 in the inserting direction is supported to be distanced from an inner surface of the pipe 111. In the first embodiment, the flowmeter 10A is attached to the pipe 111 such that the base end portion 21 of the body portion 20 is located on an upper side of the tip end portion 22 in a gravity direction and the tip end portion 22 is located on a lower side of the base end portion 21 in the gravity direction. That is, in the first embodiment, the Z direction is along the gravity direction.

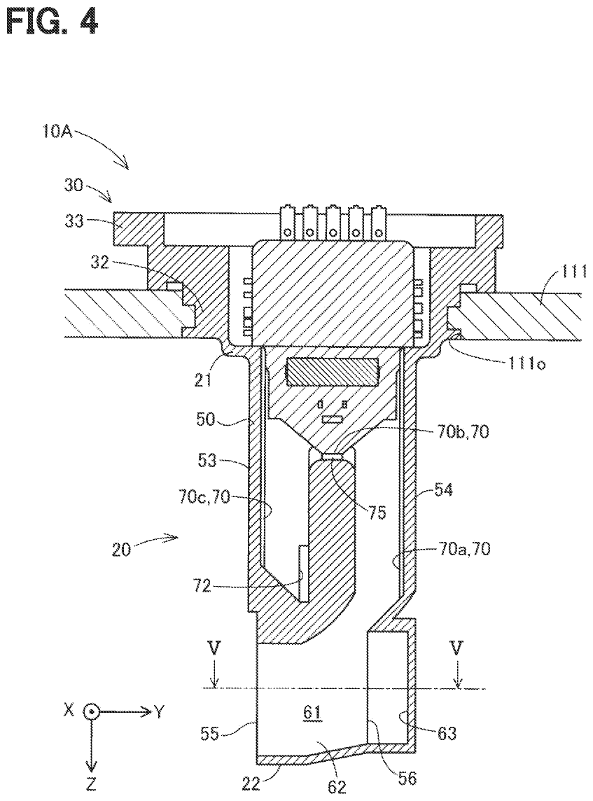

The fixing portion 30 includes a sealing portion 32 and a flange 33. The sealing portion 32 gas-tightly seals the opening 1110 of the pipe 111. The sealing portion 32 has an outer circumferential shape that is substantially the same with a shape of the opening 1110 when viewed in the Z direction. An O-ring 32r is attached to the outer circumferential of the sealing portion 32 to be gas-tightly in contact with an inner circumferential surface of the opening 111o. In FIG. 4, an illustration of the O-ring 32r is omitted for descriptive purposes. The flange 33 is disposed on the −Z side of the sealing portion 32.

As shown in FIG. 3, the flange 33 has a flat plate shape extending in the X direction and the Y direction. The flange 33 is fastened to the pipe 111 with bolts 34. The flange 33 defines bolt holes into which the bolts 34 are inserted. The pipe 111 includes bosses 111b to receive the bolts 34 at positions of the pipe 111 corresponding to the bolt holes as shown in FIG. 2. In FIG. 3, positions of the bosses 111b are shown in dashed lines for descriptive purposes. The body portion 20 of a housing 50 is fixed at a predetermined position in the pipe 111 by fixing the flange 33 to the pipe 111 with the bolts 34.

As shown in FIGS. 2 and 3, the connector portion 40 extends from the flange 33 in the X direction. As shown in FIG. 2, the connector portion 40 is supported at a position distanced from an outer circumferential surface of the pipe 111 by the flange 33. The connector portion 40 is electrically connected to a detector of the body portion 20, which will be described later, through a signal wire (not shown). The connector portion 40 is electrically connected to the ECU 140 through a cable (not shown) and outputs signals indicating measurement results to the ECU 140.

With reference to FIG. 2, in the first embodiment, the flowmeter 10A further includes a temperature sensor 41. The temperature sensor 41 is fixed to the sealing portion 32 and extends from the sealing portion 32 in the Z direction. The temperature sensor 41 is located parallel to the body portion 20 and distanced from the body portion 20 in the X direction. The temperature sensor 41 is configured to detect a temperature of the target fluid flowing through the pipe 111 and output the measurement results to the ECU 140 through the connector portion 40. The temperature sensor 41 may be omitted in other embodiments.

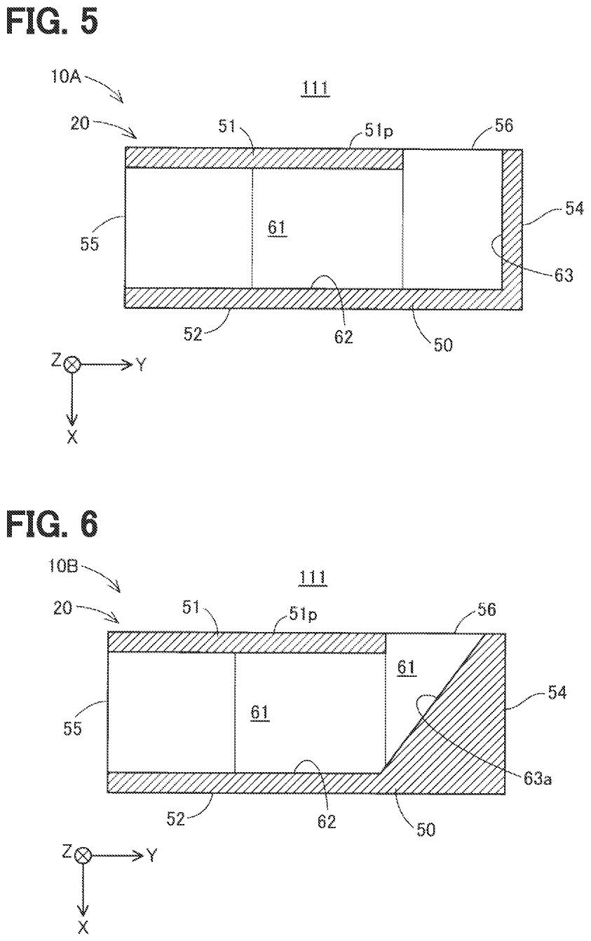

With reference to FIGS. 2, 4, and 5, the body portion 20 of the flowmeter 10A will be described. The body portion 20 includes the hollow housing 50 that defines an inner space. As shown in FIGS. 2 and 4, in the first embodiment, the housing 50 has a rectangular parallelepiped shape with flat plates. As shown in FIG. 2, the housing 50 includes a first side wall 51 and a second side wall 52 that face each other in a direction intersecting the Y direction that is the main flow direction of the target fluid in the pipe 111. In the first embodiment, the first side wall 51 and the second side wall 52 face each other in the X direction and the −X direction. The first side wall 51 is located on the −X side of the housing 50 and the second side wall 52 is located on the X side of the housing 50. In the first embodiment, when the body portion 20 is fixed to the pipe portion 111 with the fixing portion 30, the first side wall 51 and the second side wall 52 as a whole are arranged along the Y direction that is the main flow direction of the target fluid in the pipe 111 as shown in FIG. 5.

As shown in FIG. 5, the housing 50 includes a front wall 53 and a back wall 54 between the first side wall 51 and the second side wall 52. Each of the front wall 53 and the back wall 54 is connected to both of the first side wall 51 and the second side wall 52. As shown in FIG. 4, the housing 50 has a length in the Z direction that is longer than a length in the X direction of the housing 50. As shown in FIG. 5, the length in the X direction of the housing 50 is less than a length in the Y direction of the housing 50.

With reference to FIG. 2, the housing 50 includes a protecting protrusion 42 protruding in the X direction from a corner between the front wall 53 and the second side wall 52. The protecting protrusion 42 has a stick shape. The protecting protrusion 42 may be omitted.

With reference to FIGS. 2, 4, and 5, the housing 50 defines an inlet opening 55 through which the target fluid flowing through the pipe 111 flows into the housing 50. When the body portion 20 is fixed to the pipe 111 with the fixing portion 30, the inlet opening 55 opens toward an upstream end of the pipe 111 in the main flow direction of the target fluid. In the first embodiment, the inlet opening 55 opens in the front wall 53. As shown in FIG. 2, the inlet opening 55 is defined in a Z side end of the front wall 53. It is preferable that the inlet opening 55 be positioned close to the center axis of the pipe 111.

With reference to FIGS. 4 and 5, the first side wall 51 defines an outlet opening 56 through which the target fluid having flown into the housing 50 through the inlet opening 55 flows out of the housing 50. In the first embodiment, the outlet opening 56 is defined in a portion of the first side wall 51 that is located closer to a downstream end of the first side wall 51 than to an upstream end of the first side wall 51 in the main flow direction of the target fluid in the pipe 111. That is, the outlet opening 56 is defined at the Y side end of the first side wall 51. A reason the outlet opening 56 is defined in the first side wall 51 will be described later.

With reference to FIG. 5, the first side wall 51 includes a flat surface 51p that is an outer surface of the first side wall 51. The flat surface 51p extends between an upstream end of the first side wall 51 in the main flow direction (i.e., the −Y side end of the first side wall 51) and the outlet opening 56 along the Y direction that is the main flow direction of the target fluid. The flat surface 51p is a smooth flat surface without protrusions and recesses that cause substantial change of the flow of the target fluid in the main flow direction along the flat surface 51p.

When it is described in this specification that a subject is along a predetermined direction, an attitude of the subject is not limited to an attitude in parallel to the predetermined direction. The subject may have an attitude that is tilted relative to the predetermined direction by certain degrees. For example, the subject may be tilted relative to the predetermined direction by an angle equal to or less than 10 degrees. All of the subject is not necessarily along the predetermined direction. That is, if a portion or all portions of the subject is curved, it is enough that the subject as a whole is substantially arranged along the predetermined direction.

As described later, since the flowmeter 10A includes the flat surface 51p in the first side wall 51 that defines the outlet opening 56, an unexpected flow of the target fluid in the housing 50 is restricted from generating.

In the housing 50, a first passage 61 that fluidly connects between the inlet opening 55 and the outlet opening 56 is defined. In the first embodiment, the first passage 61 includes a straight passage portion 62 that extends straight from the inlet opening 55 in the Y direction.

The first passage 61 includes an end wall surface 63 that overlaps with the inlet opening 55 in the Y direction. The end wall surface 63 is a −Y side surface of the back wall 54. The end wall surface 63 extends both in the X direction and the Z direction and is substantially perpendicular to the Y direction. The end wall surface 63 extends to the outlet opening 56. The end wall surface 63 prevents the target fluid from flowing in the Y direction at an end of the first passage 61.

With reference to FIG. 4, in the housing 50, a second passage 70 that branches off from the first passage 61 is defined. In the first embodiment, the second passage 70 branches off from the first passage 61 in the −Z direction. The second passage 70 includes an inlet side passage 70a that diagonally branches off from the first passage 61 toward the back wall 54 and extends toward the base end portion 21 of the body portion 20 in the −Z direction. The second passage 70 also includes an intermediate passage 70b that is fluidly in communication with the inlet side passage 70a and that extends in the −Y direction toward the front wall 53. The second passage 70 further includes an outlet side passage 70c that extends straight in the Z direction from a −Y side end of the intermediate passage 70b toward the tip end portion 22 of the body portion 20 to a position close to the first passage 61. The outlet side passage 70c is fluidly connected to an outlet 72 opening in the first side wall 51.

The detector 75 configured to detect a flow rate of the target fluid flowing through the second passage 70 is disposed in a middle of the second passage 70. In the first embodiment, the detector 75 is disposed in the intermediate passage 70b. In the first embodiment, the detector 75 is configured to detect a flow rate of the target fluid by a temperature difference measurement method. The detector 75 includes a heater (not shown) configured to heat the target fluid and multiple temperature sensors (not shown) disposed along a flow direction of the target fluid. For example, the temperature sensors are configured with thermistors and the heater is configured with a heating resistor. The temperature sensors are located both on an upstream side and a downstream side of the heater. The detector 75 detects the flow rate of the target fluid by a temperature difference between the upstream side and the downstream side of the heater.

In the first embodiment, the detector 75 outputs a flow rate of the target fluid flowing through the second passage 70 from the first passage 61 to the detector 75 as a forward-flow flow rate. The detector 75 outputs a flow rate of the target fluid flowing through the second passage 70 from the detector 75 to the first passage 61 as a reverse-flow flow rate. The detector 75 in the first embodiment using the temperature difference method described above can detect whether the flow direction of the target fluid is the forward-flow or the reverse-flow according to a direction of a temperature gradient.

With reference to FIGS. 4 and 5, a flow of the target fluid in the housing 50 of the flowmeter 10A will be described. A portion of the target fluid flowing through the pipe 111 in the main flow direction flows into the first passage 61 in the housing 50 through the inlet opening 55. The inlet opening 55 opens toward the −Y side of the pipe 111, so that the target fluid flowing through the pipe 111 in the main direction can flow smoothly into the housing 50. The target fluid having flown into the housing 50 through the inlet opening 55 flows in the Y direction along the straight passage portion 62. The straight passage portion 62 smooths the flow of the target fluid in the first passage 61 and reduces a pressure loss of the target fluid in the first passage 61. Thus, the target fluid is assisted to flow through the housing 50.

With reference to FIG. 5, the target fluid having flown to the end wall surface 63 along the straight passage portion 62 is guided toward the outlet opening 56 in the −X direction by the end wall surface 63 and flows out of the housing 50 through the outlet opening 56. Foreign matters included in the target fluid that have weights larger than molecules of the target fluid such as dusts and water are guided to the outlet opening 56 and discharged out of the housing 50 by the flow of the target fluid along the end wall surface 63.

With reference to FIG. 4, a portion of the target fluid introduced into the first passage 61 flows into the second passage 70. As described above, since foreign matters contained in the target fluid are reflected at the end wall surface 63 and guided toward the outlet opening 56, the foreign matters are restricted from entering into the second passage 70. In the first embodiment, the second passage 70 is located at an upper portion of the first passage 61 in the gravity direction, so that the foreign matters that have large mass are effectively restricted from entering into the second passage 70. The detector 75 is configured to detect a flow rate of the target fluid flowing through the second passage 70 that is separated from the foreign matters. The target fluid passing through the detector 75 flows out of the housing 50 through the outlet 72 via the outlet side passage 70c.

Here, in the pipe 111 of the combustion system 100, the reverse-flow of the target fluid from the internal combustion engine 120 to the flowmeter 10A may occur. Also in this case, the flowmeter 10A has the outlet opening 56 at the first side wall 51 that opens in the direction perpendicular to the flow direction of the target fluid. Thus, a dynamic pressure of the reverse-flow is restricted from transmitting to the passages 61 and 70 in the housing 50 through the outlet opening 56. This restricts a generation of the vortices in the passages 61 and 70 in the housing 50, thereby smoothing the flow of the target fluid in the passages 61 and 70 in a housing 50. Therefore, a response for the change of the flow of the gas in the pipe 111 is restricted from being delayed and measurement errors of the flow rate detected by the detector 75 is reduced.

As described above, the flowmeter 10A has the first side wall 51 at which the outlet opening 56 opens and the first side wall 51 includes a flat surface 51p along the main flow direction. Thereby, when the target fluid flows through the pipe 111 in the main flow direction, a negative pressure that guides the target fluid in the housing 50 to the outside of the housing 50 through the outlet opening 56 is restricted from generating near the outlet opening 56. Thus, the target fluid in the second passage 70 is restricted from being drawn toward the outlet opening 56 due to the negative pressure, thereby restricting from generating the reverse-flow of the target fluid from the detector 75 to the first passage 61 in the second passage 70. That is, the flowmeter 10A can restrict the reverse-flow of the target fluid in the second passage 70 in the housing 50 when the target fluid flows in the main flow direction in the pipe 111. Thus, an unexpected reverse-flow in the housing 50 is prevented from causing an impairer of an accuracy of measurement results of the detector 75. As described above, the detector 75 in the first embodiment is configured to detect the flow rate of the target fluid while distinguishing the forward-flow from the reverse-flow of the target fluid. Thus, as described above, when the flow direction of the target fluid in the pipe 111 is restricted from being different from that of the target fluid in the housing 50, a measuring accuracy of the flowmeter 10A is remarkably improved.

As described above, according to the flowmeter 10A of the first embodiment, a simple configuration of the housing 50 enables to suppress a generation of the unexpected flow of the target fluid in the passages 61 and 70 in the housing 50. Therefore, the measurement error are restricted from generating. Additionally, the flowmeter 10A of the first embodiment can obtain various advantages as those described in the first embodiment.

### 2. Other Embodiments

Hereinafter, modifications of the flowmeter 10A of the first embodiment will be described as second to eighteenth embodiments. A part of the configuration of the flowmeter 10A is modified in the modifications. Configurations without particular description in the modifications are the same as those in the first embodiment. The common configurations as those in the first embodiment are given the same reference numerals in common with the first embodiment. The following embodiments can obtain the various advantages that are the same as those described in the first embodiment by including the common configurations with those in the first embodiment.

### 2-1. Second Embodiment

With reference to FIG. 6, a flowmeter 10B of a second embodiment has an end tilted surface 63a at an end portion of the first passage 61 around the outlet opening 56. The end tilted surface 63a is tilted relative to the main flow direction of the target fluid in the pipe 111. The end tilted surface 63a has a portion facing the inlet opening 55 in the Y direction and extends to the outlet opening 56. The end tilted surface 63a is tilted relative to the Y direction such that the end tilted surface 63a gradually separates away from the inlet opening 55 toward the outlet opening 56.

According to the flowmeter 10B of the second embodiment, the end tilted surface 63a smooths a flow of the target fluid from the straight passage portion 62 of the first passage 61 to the outlet opening 56. Thus, a pressure loss of the target fluid in the first passage 61 is reduced, thereby assisting the target fluid to flow through the housing 50. In addition, the end tilted surface 63a smoothly guides the foreign matters in the target fluid toward the outlet opening 56 through the straight passage portion 62. Therefore, the foreign matters are assisted to be discharged through the outlet opening 56.

### 2-2. Third Embodiment

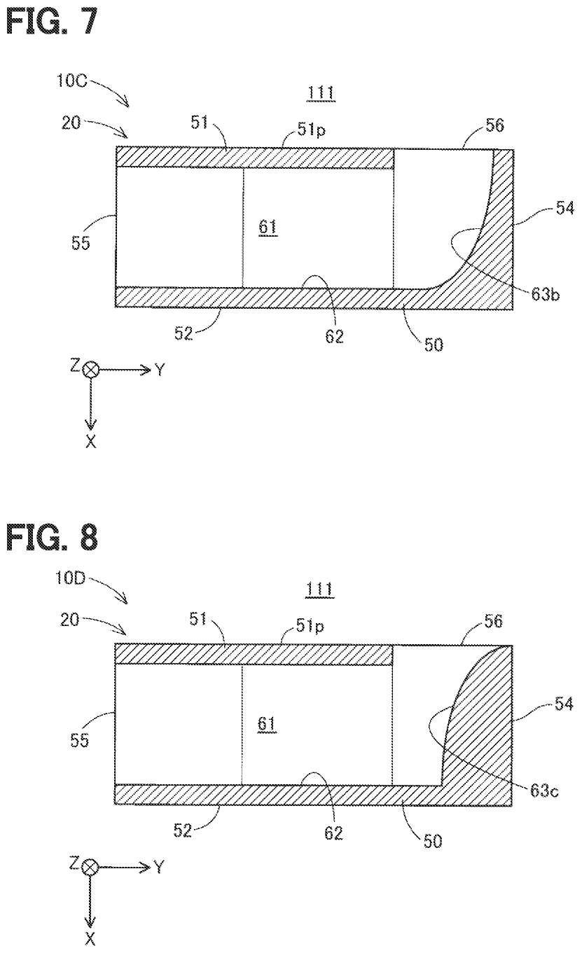

With reference to FIG. 7, a flowmeter 10C of a third embodiment has an end recessed curved surface 63b. The end recessed curved surface 63b is formed by curving the end tilted surface 63a of the second embodiment to recess in the Y direction. The end recessed curved surface 63b is another mode of the end tilted surface. The end recessed curved surface 63b has a portion facing the inlet opening 55 and extends to the outlet opening 56. The end recessed curved surface 63b is tilted relative to the main flow direction such that the end recessed curved surface 63b separates away from the inlet opening 55 toward the outlet opening 56. The end recessed curved surface 63b is smoothly connected to a surface of the straight passage portion 62 such that a corner between the end recessed curved surface 63b and the surface of the straight passage portion 62 is rounded off. The target fluid flows more smoothly from the straight passage portion 62 to the outlet opening 56 by the end recessed curved surface 63b than by the end tilted surface 63a of the second embodiment. In addition, since a sharp corner is not formed between the surface of the straight passage portion 62 and the end recessed curved surface 63b, the foreign matters contained in the target fluid are restricted from staying in such corner.

### 2-3. Fourth Embodiment

With reference to FIG. 8, a flowmeter 10D of a fourth embodiment has an end protruding curved surface 63c. The end protruding curved surface 63c is formed by curving the end tilted surface 63a of the second embodiment to protrude in the −Y direction. The end protruding curved surface 63c is another mode of the end tilted surfaces. The end protruding curved surface 63c has a portion facing the inlet opening 55 and extends to the outlet opening 56. The end protruding curved surface 63c is tilted relative to the main flow direction such that the end protruding curved surface 63c gradually separates away from the inlet opening 55 toward the outlet opening 56. According to the end protruding curved surface 63c of the fourth embodiment, a flow direction of the target fluid flowing out of the housing 50 through the outlet opening 56 can be similar to the main flow direction of the target fluid in the pipe 111. Thus, the target fluid and the foreign matters therein are assisted to smoothly flow out of the housing 50 through the outlet opening 56.

### 2-4. Fifth Embodiment

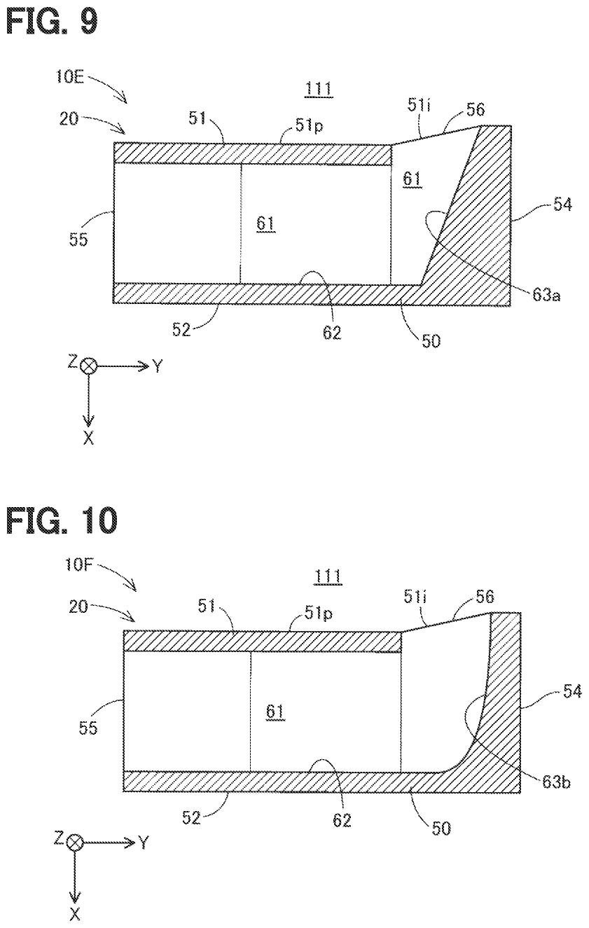

With reference to FIG. 9, a flowmeter 10E of a fifth embodiment has, at the first passage 61, the end tilted surface 63a described in the second embodiment. In addition, the flowmeter 10E of the fifth embodiment has a tilted side surface 51i at a position downstream of the flat surface 51p in the main flow direction in the pipe 111. That is, the tilted side surface 51i is formed on the Y side of the flat surface 51p. The outlet opening 56 opens at the tilted side surface 51i. The tilted side surface 51i is tilted relative to the Y direction to face the −Y side of the pipe 111 and an opening surface of the outlet opening 56 is tilted such that the outlet opening 56 opens toward the −Y direction.

According to the flowmeter 10E of the fifth embodiment, the outlet opening 56 diagonally opens in the −Y direction. Thus, the dynamic pressure of the reverse-flow of the target fluid generating in the pipe 111 is further restricted from transmitting to the passages 61 and 70 in the housing 50 through the outlet opening 56. In other embodiments, the first passage 61 may have the end wall surface 63 similar to that of the flowmeter 10A of the first embodiment in place of the end tilted surface 63a.

### 2-5. Sixth Embodiment

With reference to FIG. 10, a configuration of a flowmeter 10F of a sixth embodiment will be described. The flowmeter 10F is different from the flowmeter 10E of the fifth embodiment in that the flowmeter 10F of the fifth embodiment has the end recessed curved surface 63b that is similar to the tilted surface described in the third embodiment in place of the end tilted surface 63a that has a flat shape. The flowmeter 10F of the sixth embodiment can obtain similar advantages to those described in the fifth embodiment. In addition, the flowmeter 10F of the sixth embodiment can obtain similar advantages to those described in the third embodiment. In other embodiments, the first passage 61 may have the end protruding curved surface 63c similar to that described in the fifth embodiment in place of the end recessed curved surface 63b.

### 2-6. Seventh Embodiment

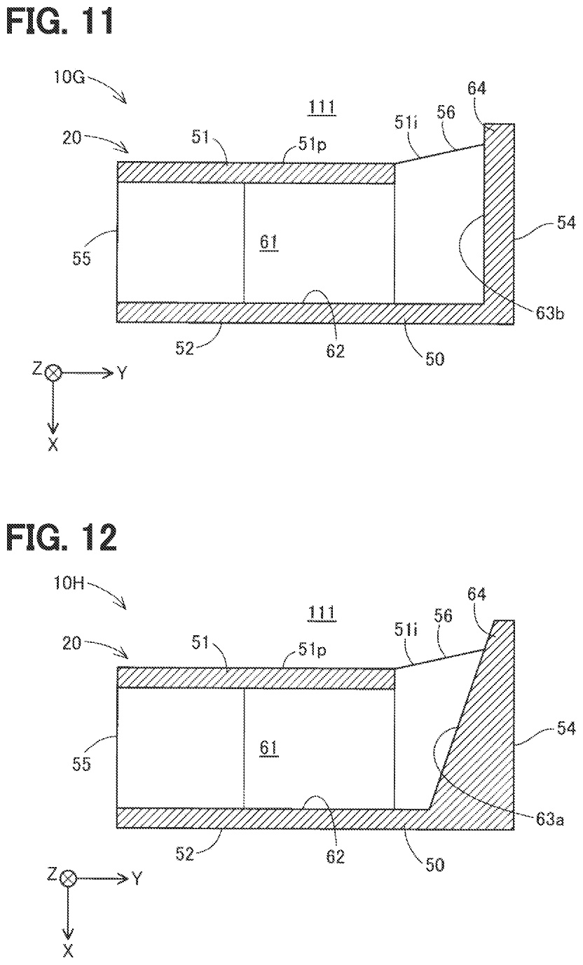

With reference to FIG. 11, a flowmeter 10G of a seventh embodiment has a protrusion 64 extending outward from the first side wall 51. The protrusion 64 is located on the Y side of the outlet opening 56, i.e., a downstream side of the outlet opening 56 in the main flow direction of the target fluid in the pipe 111. The first side wall 51 has the tilted side surface 51i similar to that described in the fifth embodiment and the outlet opening 56 opens at the tilted side surface 51i.

The protrusion 64 is a wall extending outward from the tilted side surface 51i and the outlet opening 56 in the −X direction. The protrusion 64 serves as a baffle to restrict the dynamic pressure of the reverse-flow of the target fluid generated in the main passage 111 from reaching the outlet opening 56. Thus, the protrusion 64 further restricts the target fluid flowing into the passages 61 and 70 of the housing 50 from generating vortices in the passages 61 and 70 of the housing 50, which is caused by the reverse-flow of the target fluid generated in the pipe 111.

In the flowmeter 10G of the seventh embodiment, the opening surface of the outlet opening 56 is tilted such that the outlet opening 56 faces in the −Y direction as with the flowmeter 10E of the fifth embodiment. Thus, the dynamic pressure due to the reverse-flow of the target fluid generated in the pipe 111 is further restricted from transmitting to the passages 61 and 70 of the housing 50, similarly to the fifth embodiment. In other embodiments, the tilted side surface 51i of the first side wall 51 may be omitted.

### 2-7. Eighth Embodiment

With reference to FIG. 12, a flowmeter 10H of an eighth embodiment is different from the flowmeter 10G of the seventh embodiment in that the flowmeter 10H has the end tilted surface 63a similar to that in the second embodiment. A −Y side surface of the protrusion 64 is formed by a tilted surface that continuously extends from the end tilted surface 63a. The end tilted surface 63a of the flowmeter 10H of the eighth embodiment can smooth the discharge of the target fluid and foreign matters outward from the housing 50 through the outlet opening 56.

### 2-8. Ninth Embodiment

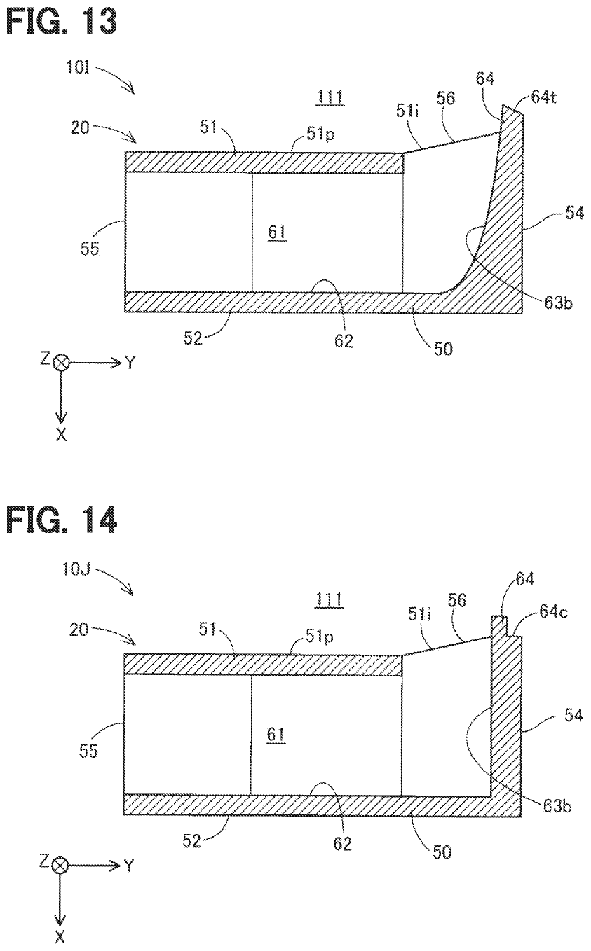

With reference to FIG. 13, a flowmeter 10I of a ninth embodiment is different from the flowmeter 10H of the eighth embodiment in that the flowmeter 10I includes the end recessed curved surface 63b similar to that described in the third embodiment and the protrusion 64 has an end surface 64t. Other portions are similar to those in the flowmeter 10H of the eighth embodiment.

The end recessed curved surface 63b of the flowmeter 10I of the ninth embodiment can further assist the target fluid and foreign matters to smoothly flow out of the housing 50 through the outlet opening 56. The end surface 64t of the protrusion 64 located on the −X side of the protrusion 64 is tilted to face the Y side of the protrusion 64. The end surface 64t guides the reverse-flow of the target fluid generated in the pipe 111 to flow away from the outlet opening 56. Thus, according to the flowmeter 10I of the ninth embodiment, the dynamic pressure due to the reverse-flow of the target fluid generated in the pipe 111 is further restricted from transmitting to the passages 61 and 70 of the housing 50 through the outlet opening 56.

In other embodiments, the first passage 61 may include the end protruding curved surface 63c of the fourth embodiment that is curved to protrude in the −Y direction in place of the end recessed curved surface 63b. The end surface 64t of the protrusion 64 may be applied to the protrusion 64 of the above described other embodiments.

### 2-9. Tenth Embodiment

With reference to FIG. 14, a configuration of a flowmeter 10J of the tenth embodiment is different from the flowmeter 10G of the seventh embodiment in that the flowmeter 10J includes a step 64c at a −X side end portion of the protrusion 64. The protrusion 64 includes the step 64c that is recessed from a Y side portion of the protrusion 64 in the −Y direction in a stepped manner. The flowmeter 10J of the tenth embodiment restricts the reverse-flow of the target fluid generated in the pipe 11 from flowing toward the outlet opening 56. Thus, the dynamic pressure of the reverse-flow of the target fluid generated in the pipe 111 is further restricted from transmitting to the passages 61 and 70 in the housing 50 through the outlet opening 56. The step 64c of the protrusion 64 may be applied to the protrusion 64 in other embodiments described above.

### 2-10. Eleventh Embodiment

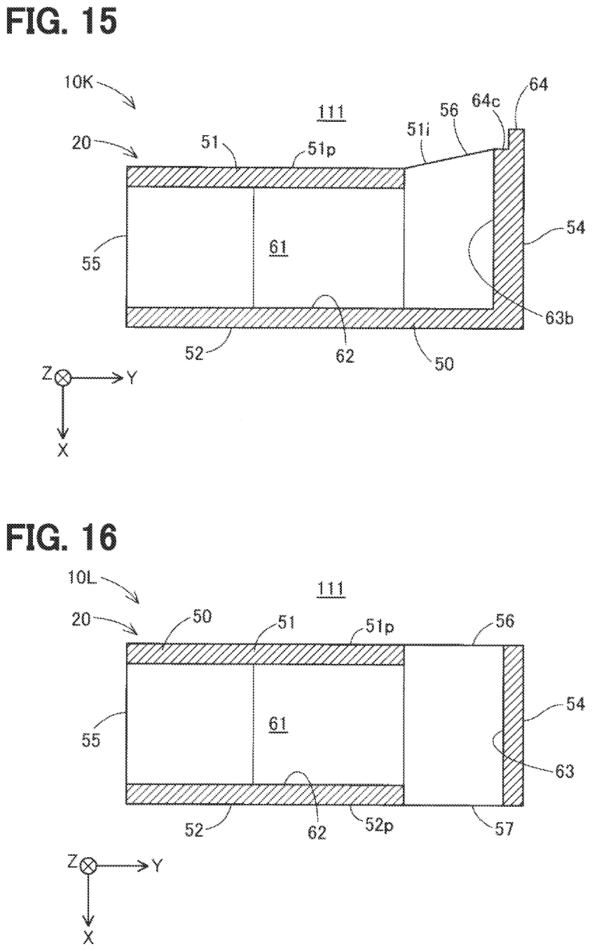

With reference to FIG. 15, a configuration of a flowmeter 10K of an eleventh embodiment is different from the flowmeter 10J of the tenth embodiment in that the flowmeter 10K includes the step 64c at a −Y side end of the protrusion 64. The flowmeter 10K of the eleventh embodiment also can restrict the reverse-flow generated in the pipe 111 from flowing toward the outlet opening 56 by the step 64c. The step 64c of the eleventh embodiment can be applied to other embodiments described above.

### 2-11. Twelfth Embodiment

With reference to FIG. 16, a flowmeter 10L of a twelfth embodiment includes an outlet opening 56 at the second side wall 52 in addition to the outlet opening 56 at the first side wall 51. Hereinafter, in order to distinguish the two outlet openings 56 and 57, the outlet opening 56 at the first side wall 51 is referred to as “a first outlet opening 56” and the outlet opening 57 at the second side wall 52 is referred to as “a second outlet opening 57”.

The second outlet opening 57 is fluidly connected to the first passage 61. The second outlet opening 57 is located at a position overlapping with the first outlet opening 56 in the X direction. The end wall surface 63 continuously extends between the first outlet opening 56 and the second outlet opening 57. The flowmeter 10L of the twelfth embodiment can further prompt the target fluid to flow through the housing 50 with the second outlet opening 57. In addition, foreign matters in the target fluid are further prompted to flow out of the housing 50.

The flowmeter 10L of the twelfth embodiment has a flat surface 52p that is an outer surface of the second side wall 52 to the flat surface 51p of the first side wall 51. Hereinafter, in order to distinguish the two flat surfaces 51p and 52p, the flat surface 51p of the first side wall 51 is referred to as “a first flat surface 51p” and the flat surface 52p of the second side wall 52 is referred to as “a second flat surface 52p”.

The second flat surface 52p continuously extends between an upstream end of the second side wall 52 in the main flow direction, i.e., the −Y side end of the second side wall 52, and the second outlet opening 57 in the main flow direction. The second flat surface 52p is a smooth surface without protrusions and recesses that cause the flow of the target fluid in the main flow direction along the second flat surface 52p to change.

The second flat surface 52p of the second side wall 52 restricts from generating, near the second outlet opening 57, a negative pressure that guides the target fluid in the housing 50 outward of the housing 50 through the second outlet opening 57 when the target fluid flows through the pipe 111 in the main flow direction. Thus, the target fluid in the second passage 70 is restricted from being drawn toward the second outlet opening 57 by the negative pressure, thereby restricting from generating the reverse-flow of the target fluid in the second passage 70 from the detector 75 to the first passage 61. In addition, the accuracy of the measurement results of the detector 75 is restricted from being reduced due to the generation of the unexpected reverse-flow of the target fluid in the housing 50.

### 2-12. Thirteenth Embodiment

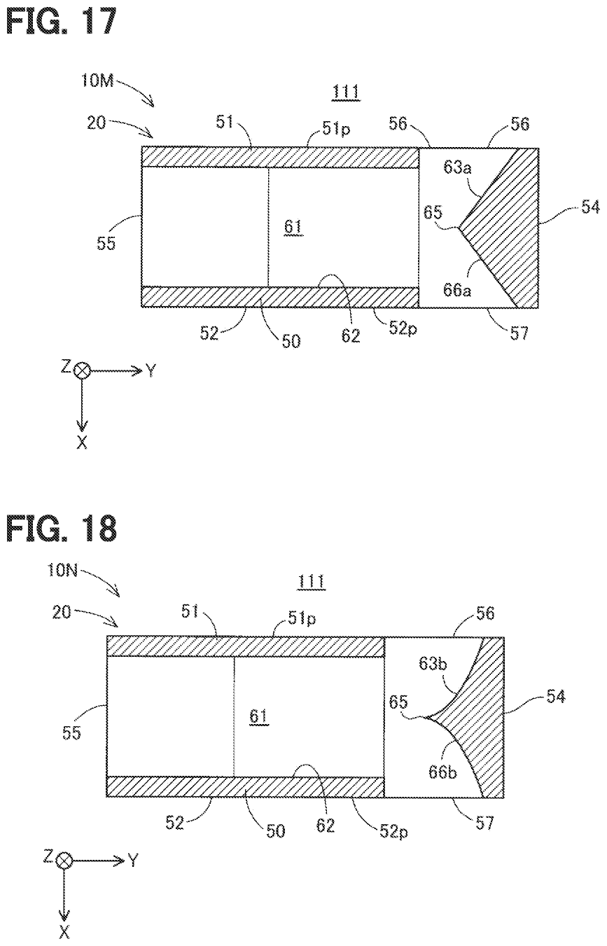

With reference to FIG. 17, a configuration of a flowmeter 10M of a thirteenth embodiment is different from that of the flowmeter 10L of the twelfth embodiment in that the flowmeter 10M includes an end tilted surface 63a for the first outlet opening 56 and an end tilted surface 66a for the second outlet opening 57 at the end portion of the first passage 61. Hereinafter, the end tilted surface for the first outlet opening 56 is referred to as “a first end tilted surface 63a” and the end tilted surface for the second outlet opening 57 is referred to as “a second end tilted surface 66a”.

The first end tilted surface 63a has a portion facing the inlet opening 55 in the Y direction and extends to the first outlet opening 56 as described in the second embodiment. The first end tilted surface 63a is tilted relative to the Y direction such that the first end tilted surface 63a gradually separates away from the inlet opening 55 toward the first outlet opening 56.

The second end tilted surface 66a has a portion facing the inlet opening 55 in the Y direction and extends to the second outlet opening 57. The second end tilted surface 66a is tilted relative to the Y direction such that the second end tilted surface 66a gradually separates away from the inlet opening 55 toward the second outlet opening 57.

In the flowmeter 10M, the first end tilted surface 63a smooths the flow of target fluid and the foreign matters in the target fluid from the first passage 61 toward the first outlet opening 56. In addition, the second end tilted surface 66a smooths the flow of the target fluid and the foreign matters in the target fluid from the first passage 61 toward the second outlet opening 57.

The flowmeter 10M includes a corner 65 protruding toward the inlet opening 55 in the −Y direction between the two end tilted surfaces 63a and 66a. The first end tilted surface 63a is connected to the second end tilted surface 66a at the corner 65. The corner 65 is located at a position facing the inlet opening 55 in the Y direction. Preferably, the corner 65 is located on an extending line of a center axis of the straight passage portion 62. The corner 65 serves as a branched portion to smoothly separate the target fluid into one portion of the target fluid flowing through the first passage 61 toward the first outlet opening 56 and the other portion of the target fluid toward the second outlet opening 57. The corner 65 can smooth the flow of the target fluid in the first passage 61 toward the two outlet openings 56 and 57. In other embodiments, an end surface formed by cutting off a portion of the corner 65 may be provided between the two end tilted surfaces 63a and 66a.

### 2-13. Fourteenth Embodiment

With reference to FIG. 18, a flowmeter 10N of a fourteenth embodiment includes a first end recessed curved surface 63b and a second end recessed curved surface 66b. The first end recessed curved surface 63b is formed by curving the first end tilted surface 63a to be recessed toward the Y direction and the second end recessed curved surface 66b is formed by curving the second end tilted surface 66a to be recessed toward the Y direction. Other configurations of the flowmeter 10N of the fourteenth embodiment are almost the same with those of the flowmeter 10M of the thirteenth embodiment.

The first end recessed curved surface 63b is another aspect of the first end wall. The first end recessed curved surface 63b has a portion facing the inlet opening 55 and extends to the first outlet opening 56. The first end recessed curved surface 63b is tilted relative to the main flow direction such that the first end recessed curved surface 63b gradually separates away from the inlet opening 55 toward the first outlet opening 56. The second end recessed curved surface 66b is another aspect of the second end wall. The second end recessed curved surface 66b includes a portion facing the inlet opening 55 and extends to the second outlet opening 57. The second end recessed curved surface 66b is tilted relative to the main flow direction such that the second end recessed curved surface 66b gradually separates away from the inlet opening 55 toward the second outlet opening 57. The flowmeter 10N of the fourteenth embodiment can smooth the flow of the target fluid in the first passage 61 toward the two outlet openings 56 and 57.

### 2-14. Fifteenth Embodiment

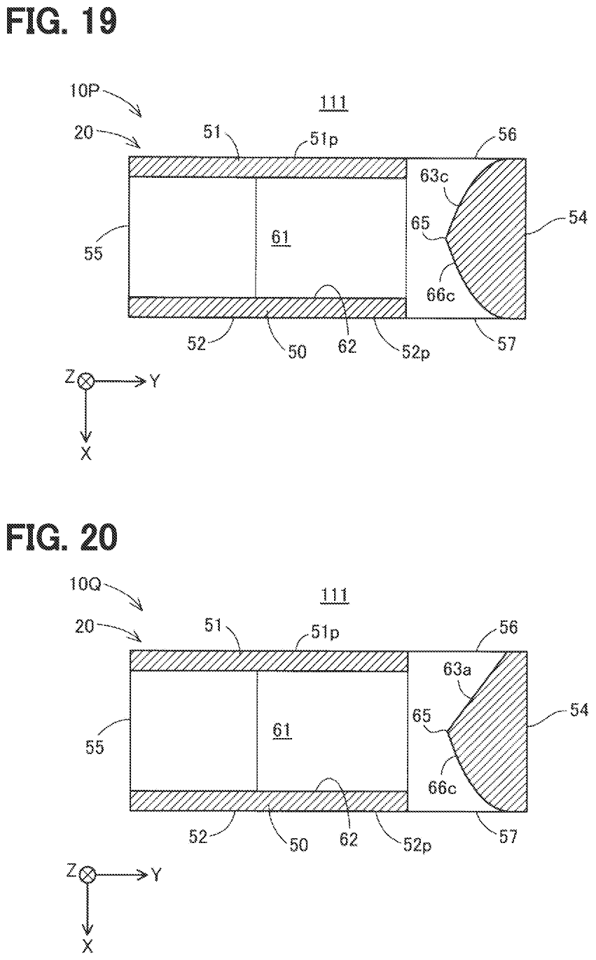

With reference to FIG. 19, a flowmeter 10P of a fifteenth embodiment includes a first end protruding curved surface 63c and a second end protruding curved surface 66c. The first end protruding curved surface 63c is formed by curving the first end tilted surface 63a to protrude in the −Y direction. The second end protruding curved surface 66c is formed by curving the second end tilted surface 66a to protrude in the −Y direction. Other configurations of the flowmeter 10P of the fifteenth embodiment are almost the same with those of the flowmeter 10M of the thirteenth embodiment.

The first end protruding curved surface 63c is another aspect of the first end wall. The first end protruding curved surface 63c includes a portion facing the inlet opening 55 and extends to the first outlet opening 56. The first end protruding curved surface 63c is tilted relative to the main flow direction such that the first end protruding curved surface 63c gradually separates away from the inlet opening 55 toward the first outlet opening 56. The second end protruding curved surface 66c is another aspect of the second end wall. The second end protruding curved surface 66c includes a portion facing the inlet opening 55 and extends to the second outlet opening 57. The second end protruding curved surface 66c is tilted relative to the main flow direction such that the second end protruding curved surface 66c gradually separates away from the inlet opening 55 toward the second outlet opening 57. The flowmeter 10P of the fifteenth embodiment can smooth the flow of the target fluid in the first passage 61 toward the two outlet openings 56 and 57.

### 2-15. Sixteenth Embodiment

With reference to FIG. 20. a configuration of a flowmeter 10Q of a sixteenth embodiment is different from the flowmeter 10P of the fifteenth embodiment in that the flowmeter 10Q includes the end tilted surface 63a described in the thirteenth embodiment in place of the first end protruding curved surface 63c. The passage 61 may be asymmetrically formed between a portion around the first outlet opening 56 and a portion around the second outlet opening 57.

In other embodiments, the first end recessed curved surface 63b may be provided in place of the first end tilted surface 63a. The second end recessed curved surface 66b may be provided in place of the second end protruding curved surface 66c. When the first end recessed curved surface 63b is provided in place of the first end tilted surface 63a, the second end tilted surface 66a may be provided in place of the second end protruding curved surface 66c. When the first end protruding curved surface 63c is provided in place of the first end tilted surface 63a, the second end tilted surface 66a or the second end recessed curved surface 66b may be provided in place of the second end protruding curved surface 66c.

### 2-16. Seventeenth Embodiment

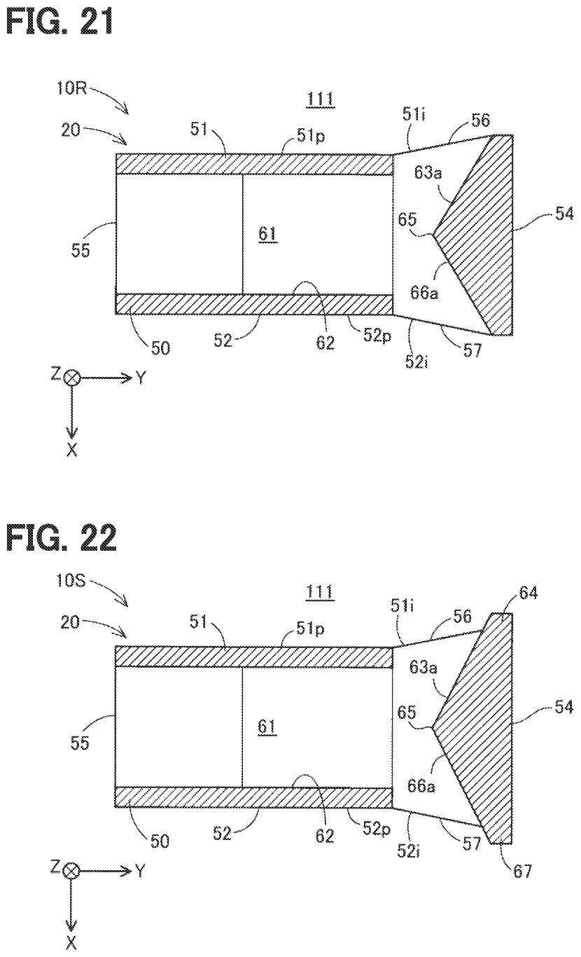

With reference to FIG. 21, a configuration of a flowmeter 10R of a seventeenth embodiment is almost the same with that of the flowmeter 10M of the thirteenth embodiment except for the following points which are described below. In the flowmeter 10R of the seventeenth embodiment, the first side wall 51 includes a tilted side surface 51i defining the first outlet opening 56 and the second side wall 52 includes a tilted side surface 52i defining the second outlet opening 57.

As described in the fifth embodiment, the tilted side surface 51i of the first side wall 51 is located on the Y side of the first flat surface 51p and tilted relative to the Y direction to face the −Y side of the tilted side surface 51i. The first outlet opening 56 defined at the tilted side surface 51i diagonally opens toward the −Y direction. The tilted side surface 52i of the second side wall 52 is located on the Y side of the second flat surface 52p and tilted relative to the Y direction to face the −Y side of the tilted side surface 52i. The second outlet opening 57 defined at the tilted side surface 52i diagonally opens toward the −Y direction.

According to the flowmeter 10R of the seventeenth embodiment, the dynamic pressure of the reverse-flow of the target fluid generated in the pipe 111 is restricted from transmitting to the passages 61 and 70 in the housing 50 through the first outlet opening 56 and the second outlet opening 57. In other embodiments, either one of the tilted side surface 51i of the first side wall 51 and the tilted side surface 52i of the second side wall 52 may be omitted. Additionally, in other embodiments, the end wall surface 63 extending in the X direction may be provided in place of the two end tilted surfaces 63a and 66a. Alternatively, the end recessed curved surfaces 63b and 66b or the end protruding curved surfaces 63c and 66c may be provided in place of the two end tilted surfaces 63a and 66a.

### 2-17. Eighteenth Embodiment

With reference to FIG. 22, a configuration of the flowmeter 10G of the eighteenth embodiment is different from the flow meter 10R of the seventeenth embodiment in that the flowmeter 10S additionally includes the protrusion 64 for the first outlet opening 56 and a protrusion 67 for the second outlet opening 57. Hereinafter, the protrusion 64 for the first outlet opening 56 is referred to as “a first protrusion 64” and the protrusion 67 for the second outlet opening 57 is referred to as “a second protrusion 67”.

According to the flowmeter 10S of the eighteenth embodiment, the two protrusions 64 and 67 serve as baffles that restrict the reverse-flow of the fluid generated in the pipe 111 from flowing toward the two outlet openings 56 and 57. Thus, when the reverse-flow of the target fluid is generated in the pipe 111, the dynamic pressure of the reverse-flow is restricted from transmitting to the passages 61 and 70 in the housing 50 through the two outlet openings 56 and 57. Thus, vortices generated by the target fluid flowing into the housing 50 through the first outlet opening 56 are reduced in the passages 61 and 70 in the housing 50.

In other embodiments, either one of the two protrusions 64 and 67 may be omitted. Further, in other embodiments, at least one of the two protrusions 64 and 67 may have the step 64c as those described in the tenth embodiment and the eleventh embodiment. In other embodiments, at least one of the tilted side surfaces 51i and 52i may be omitted. Further, in other embodiments, the end wall surface 63 extending in the X direction may be provided in place of the two end tilted surface 63a and 66a. Alternatively, the end recessed curved surfaces 63b and 66b or the end protruding curved surfaces 63c and 66c may be provided in place of the two end tilted surfaces 63a and 66a.

### 3. Other Embodiments

Various configurations described in above embodiments may be modified for example as follows. Other embodiments described below are positioned as one aspect to implement techniques of the present disclosure as with the above described embodiments.

### Another Embodiment 1

In the above-described embodiments, the housing 50 may have a shape other than a rectangular parallel piped shape. For example, the housing 50 may have an elliptic cylinder shape having an elliptical cross section that has a longitudinal direction in the Y direction.

### Another Embodiment 2

In the above-described embodiments, the first side wall 51 and the second side wall 52 may be replaced with each other such that the first side wall 51 defining the outlet opening 56 is located on the X side of the flowmeter and the second side wall 52 is located on the −X side of the flowmeter.

### Another Embodiment 3

In the above-described embodiments, the detector 75 may employ another type flow rate sensor in place of the thermo-differential type. The detector 75 may employ a Coriolis type or a Kerman vortex type sensor. The detector 75 may not distinguish the forward-flow flow rate from the reverse-flow flow rate.

### Another Embodiment 2

The flowmeters 10A to 10N, 10P to 10S in the above-described embodiments may be attached to a place other than the pipe 111 of the combustion system 100 mounted in the vehicle. The flowmeters 10A to 10N, 10P to 10S in the above-described embodiments may be attached to a pipe through which a reaction gas used for generating electricity is supplied into a fuel cell in a fuel cell system.

The techniques of the present disclosure can be achieved in various modes other than the flow rate measuring device. For example, the techniques can be achieved in a housing used for the flow rate measuring device, a flow configuration of the flow rate measuring device, a flow rate measuring system, and the like.

The techniques in the present disclosure are not limited to the above described embodiments and other embodiments and may be achieved in various configurations as long as departing from a gist of the present disclosure. For example, to solve a part or all parts of the above-described subjects, or to obtain a part or all of the above-described advantages, the technical features in the embodiments and modifications that correspond to the technical features described in summary can be appropriately replaced or combined with each other. In addition, the technical features can be appropriately deleted not only when the technical features are described that the technical features are not necessary but also when the technical features are not described to be necessary in the specification.

What is claimed is:

1. A flowmeter configured to measure a flow rate of a target fluid flowing through a pipe, the flowmeter comprising:
a hollow housing that includes a first side wall and a second side wall facing each other in a direction intersecting a main flow direction of the target fluid, the housing defining an inlet opening that opens toward an upstream side of the pipe in the main flow direction and an outlet opening that is defined in the first side wall, the target fluid flowing into the housing through the inlet opening and out of the housing through the outlet opening;
a first passage that is defined in the housing and fluidly connects between the inlet opening and the outlet opening, the target fluid flowing through the first passage;
a second passage that is defined in the housing and branches off from the first passage, a portion of the target fluid in the first passage flowing into the second passage;
a detector that is disposed in the second passage and configured to detect a flow rate of the target fluid flowing through the second passage; and
a flat surface that is an outer surface of the first side wall and extends between an upstream end of the first side wall in the main flow direction and the outlet opening along the main flow direction.

2. The flowmeter according to claim 1, wherein
the outlet opening is a first outlet opening,
the flat surface is a first flat surface,
the second side wall defines a second outlet opening that is fluidly connected to the first passage, a portion of the fluid in the first passage flowing out of the first passage through the second outlet opening, and
the second side wall includes a second flat surface that is an outer surface of the second side wall and extends between an upstream end of the second side wall in the main flow direction and the second outlet opening along the main flow direction.

3. The flowmeter according to claim 1, wherein
the first passage includes an end tilted surface at an end portion of the first passage around the outlet opening,
the end tilted surface is tilted relative to the main flow direction such that the end tilted surface gradually separates away from the inlet opening toward the outlet opening, and
the end tilted surface includes a facing portion facing the inlet opening and continuously extends to the outlet opening.

4. The flowmeter according to claim 1, wherein
the first side wall includes a protrusion at a position downstream of the outlet opening in the main flow direction, and
the protrusion protrudes outward from the first side wall.

5. The flowmeter according to claim 2, wherein
the first passage includes:
a first end tilted surface at an end portion of the first passage around the first outlet opening; and
a second end tilted surface at an end portion of the first passage around the second outlet opening,
the first end tilted surface is tilted relative to the main flow direction such that the first end tilted surface gradually separates away from the inlet opening toward the first outlet opening,
the first end tilted surface includes a facing portion facing the inlet opening and continuously extends to the first outlet opening,
the second end tilted surface is tilted relative to the main flow direction such that the second end tilted surface gradually separates away from the inlet opening toward the second outlet opening, and
the second end tilted surface includes a facing portion facing the inlet opening and continuously extends to the second outlet opening.

6. The flowmeter according to claim 5, wherein
the first end tilted surface and the second end tilted surface are connected to each other at a corner, and
the corner faces the inlet opening in the housing.

7. The flowmeter according to claim 2, wherein
the first side wall includes a first protrusion at a position downstream of the first outlet opening in the main flow direction, the first protrusion protruding outward from the first side wall, and
the second side wall includes a second protrusion at a position downstream of the second outlet opening in the main flow direction, the second protrusion protruding outward from the second side wall.

8. The flowmeter according to claim 1, wherein
the detector is configured to:
output a flow rate of the target fluid flowing from the first passage to the detector as a forward-flow flow rate; and
output a flow rate of the target fluid flowing from the detector to the first passage as a reverse-flow flow rate.
